(19) United States
(12) Patent Application Publication
(10) Pub. No.: US 2003/0008715 A1
(43) Pub. Date: Jan. 9, 2003

(54) Program-controlled, money-operated entertainment and gaming apparatus

(76) Inventors: Anton Huber, Muenster-Sarmsheim (DE); Horst Niederlein, Bingen (DE)

Correspondence Address: PATENTS-TMS, A Professional Corporation, 1914 North Milwaukee Avenue, Chicago, IL, 60647, US

(21) Appl. No.: 10/241,142

(22) Filed: Sep. 11, 2002

Related U.S. Application Data
(63) Continuation of application No. 08/945,790, filed on Nov. 4, 1997.
Application No. 08/945,790 is a 371 of international application No. PCT/DE96/00954, filed on May 31, 1996.

(30) Foreign Application Priority Data
Jun. 1, 1995 (DE) 195 20 086.1

(51) Int. Cl. G06F 19/00

(52) U.S. Cl. 463/43

(57) ABSTRACT

A program-controlled entertainment and game apparatus includes a storage section, preferably in the form of one or more optical or magnetic disks. A data compression technique, such as MPEG (“MOTION PICTURE EXPERT GROUP”), is employed.

This application is a continuation of U.S. patent application Ser. No. 08/945,790 filed on Nov. 4, 1997.

### BACKGROUND OF THE INVENTION

The invention relates to a program-controlled, money-operated entertainment and gaming apparatus having a storage device, in particular, as a jukebox.

In order to provide a versatile and varied gaming operation, DE 43 31 258 A1 proposed a program-controlled entertainment apparatus wherein are included a housing, a display which is connected to or provided in the housing, particularly a screen, operating elements associated with the housing, a control unit provided in the housing and a storage device associated with the housing, n which storage device program information and data information are stored. This program-controlled entertainment and gaming apparatus can be used according to the respective program that is stored in the storage device. In this manner, it can be designed entirely to correspond the requirements with regard to its function in that, depending on the situation, new program information and data information are read in and stored. A restoring process of this type has the effect that the characteristics of the gaming apparatus change, i.e., it is possible, e.g., to play a different game variant. However, by reading in an entirely different program or game, it is also possible to completely change the function of the gamin apparatus. If, e.g., the gaming apparatus was first a money gamin apparatus, it can subsequently be an apparatus for a game of skill, whatever is desired. These entirely different apparatuses have the hardware components of the apparatus in common such as housing, display, operating elements, control unit and the storage device with variable storage contents, with the different games being stored in the storage device.

The storage unit of the known entertainment and gaming apparatus can comprise a hard disk. Alternatively or additionally, one or serval CD ROM's as data carriers can be provided in the housing. It is advantageous for a rapid changing of the CD ROM if a CD ROM magazine is provided for the storing and reading of the data carriers. One or several EPROM's can also be provided as storage device. The game action can be integrated into the respective apparatus via these EPROM's.

In an embodiment of the known entertainment and gaming apparatus, the apparatus is connected to a remote data transmission line, with it being possible to store the received data, for example, on the hard disk. Thus, the gaming operation can be d3esigned to be very flexible. The data can be exchanged, e.g. by the installer but alternatively also by the user, i.e., the player. If the installer notices, for example, that the gaming apparatus concerned is used considerably less frequently, he/she merely needs to exchange the store game for another game, in which there seems to be a greater interest, by means of a command and the corresponding reading in of new gamin data.

According to the above, extensive program data and gaming data are required for an entertainment and gaming apparatus of this type because the apparatus is only defined with respect to its use by means of the data received. In spite of the numerous storage capacities, which have become possible in the last few years, such data amounts still present a problem. Because of the large data turnover, delays occur duri9ng the transmission and storage of dat as well as during the use of the entertainment and gaming apparatuses, i.e., undesirable delays occur. In addition, there is the problem of data security.

To facilitate a versatile and interesting gaming operation, DE 42 22 110 A1 has proposed a program-controlled entertainment and gaming apparatus having a playback unit for a CDI disk on which the program information and data information are store. The respective use of the apparatus is determined by the program which is permanently stored on the CDI disk and, in this manner, the apparatus can be design specifically to meet the requirements with regard to its function. The CDI disk makes it possible for the gamin action to b run in an unexpectedly varied manner. It is possible to select different gamin functions interactively at top speed and to combine them with one another.

Furthermore, it is also possible when selecting a specific function and the immediately following display to select a further game function from this display. In this manner, jumps are made from one level of the game into the next, with it being permitted, of course, to jump from and into the different levels in an alternating manner at any time. Thus, the gaming possibilities are expanded remarkably compared to conventional entertainment and gamin apparatuses. But the problems of the large data volumes which must be processed occur in this configuration as well.

From the field of computer applications it is known to deposit data in storage media in a compressed and/or interlaced manner to save storage space and to enhance data security. The data must be decoded so that they can be read later. Depending on the architecture of the storage organization and of the software that is used, the storage data can be accessed in a correspondingly rapid manner.

### SUMMARY OF THE INVENTION

It is the object of the invention to propose an entertainment and gaming apparatus which allows a versatile and varied as well as swift gaming operation at the same time.

According to the invention, this object is solved in a program-controlled, money-operated entertainment and gaming apparatus having a storage device in which program information and data information are stored, with MPEG decoding and/or compression being employed for the processing of data.

The MPEG process (a standard defined by the Motion Picture Expert Group for video and audio compression) makes it possible to work with large storage volumes and high data transfer rates. Here, the data can be interlaced just like in telecommunication engineering.

Preferably, the storage device comprises a disk, in particular, a hard disk, with magnetic or optical disks being use.

According to an advantageous embodiment of the invention, one or several CDR's, including CD-ROM's, CDI's, can be provided as data carriers in the housing.

In this manner, the entertainment and gaming apparatus according to the invention can be played not only in a very varied manner but also with the necessary game speed. The implementation of an apparatus for a different type of application can be carried out with sufficient speed because of the use of the MPEG method.

The data exchanges can, of course, be carried out at the respectively desired moment and are not tied to the gaming operation, in principle, i.e., usually the data transmission does not take place on-line.

It is advantageous for the program-controlled, money-operated entertainment and gaming apparatus according to the invention to be connected to a network, with a server being provided for the control of the apparatus of a network associated with the apparatus.

The invention is explained in greater detail by way of the description of an embodiment which follows.

### BRIEF DESCRIPTION OF THE DRAWINGS

FIG. 1 is a schematic diagram illustrating the fundamental design of a first embodiment of a program-controlled, money operated entertainment and gaming apparatus according to the invention.

### DETAILED DESCRIPTION OF THE PRESENTLY PREFERRED EMBODIMENTS

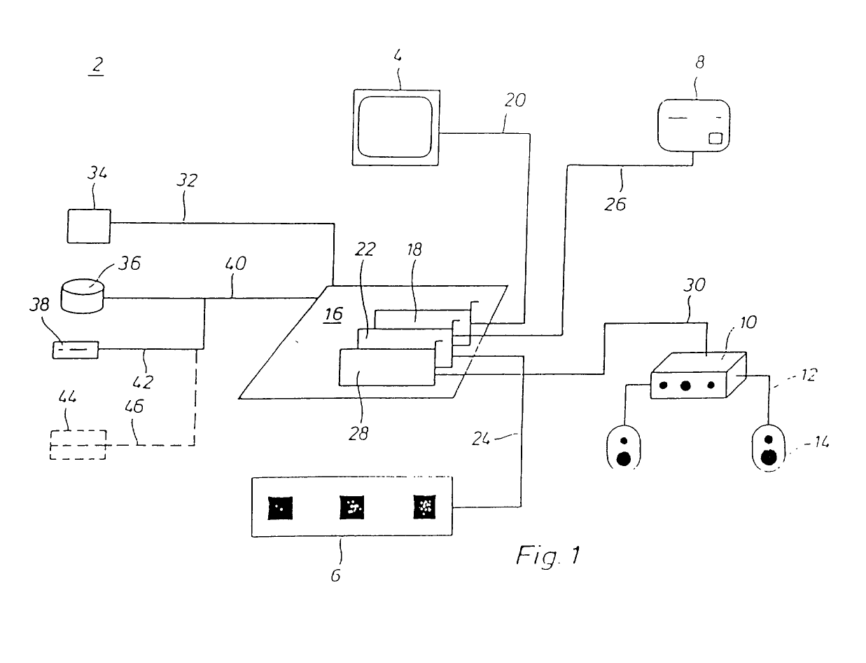

The fundamental design of a program-controlled entertainment and gaming apparatus according to the invention is explained in the following by way of the embodiment of FIG. 1. The illustrated entertainment and gaming apparatus 2 is coin-operated and stands-alone. It includes a housing, not shown, and is connected a display 4 in the form of a screen, e.g., a VGA monitor is connected with the housing. Furthermore, operating elements 6 in the form of an input keyboard are connected with the housing. A coin processing unit 8 is provided for the coin-operated gamin operation. Furthermore, there is connected with the apparatus an acoustic indication and entertainment unit compromising a stereo amplifier 10 and loudspeakers 14 which are connected with the amplifier by way of two connecting lines 12.

A control unit is accommodated on a system board 16 which may be a commercially available system card. It is provided with a DVI card 18, with DVI “Digital Video Interactive” being a trademark of the Intel Corporation, USA. The DVI card 18 is connected to the display 4 via a line 20. An I/O module 22 is connected to the operating elements 6 via a line 24 and with the coin processing unit 8 via a line 26. An audio card, a so-called sound board 28, is connected with the stereo amplifier 10 via a line 30.

The system board 16 is connected to a power supply unit 34 via a supply line 32. A storage section allocated to the housing comprises a hard disk 36 and a floppy disk station 38 or floppy disks which are connected to the system board 16 via lines 40 or 42. Optionally, a CD-ROM 44, illustrated in dashed lines, can be provided which is connected to the system board 16 via a line 46, also shown in dashed lines. The MPEG method is employed for the data compression and the data decoding.

As can be seen from the above description of the design of the apparatus, the entertainment and gaming apparatus is suited, because it can combine graphics, freezing frames and moving images and audio unit, for an extremely flexible operation with the assistance of a single computer. For the respectively desired device function or device variant, it is merely required to read a corresponding program with associated data into the storage section. The apparatus then functions in accordance with this new function input.

If the described entertainment and gaming apparatus is reconfigured accordingly, it can be operated in conjunction with an external server or an external evaluation unit. The server or the evaluation unit is comprised of a computer which is operated by the installer; the computer initiates contact with the computers of the individual gaming sites via a remote data transmission connection and monitors the individual apparatuses or assumes their evaluation. It is also possible to transfer new software to the local hard disks of the server itself.

A networked apparatus configuration with local server and remote data transmission connection to an external server or an external evaluation unit is also feasible.

Naturally, the invention is not limited to the embodiments that are shown and described. It also comprised other configurations and partial combinations of the features that are claimed, described and/or illustrated.

It should be understood that various changes and modifications to the presently preferred embodiments described herein will be apparent to those skilled in the art. Such changes and modifications may be made without departing from the spirit and scope of the present invention and without diminishing its attendant advantages. It is, therefore, intended that such changes and modifications be covered by the appended claims.

We claim:

1. An entertainment and gaming apparatus comprising:
a housing;
a display connected to the housing;
an operating element connected to the housing;
an amplifier connected to the housing;
storage section means for storing program information and data information wherein the data information is compressed; and
a control unit connected to the display, the operating element, and the storage section means, wherein the control unit restores the compressed data information and activates the program information and the data information to visually depict a game sequence on the display in response to manual actuation of the operating element.

2. The apparatus of claim 1 further comprising:
a disk associated with the storage section means.

3. The apparatus of claim 2 wherein the disk is a magnetic disk.

4. The apparatus of claim 3 wherein the magnetic disk is a hard disk.

5. The apparatus of claim 2 wherein the disk is an optical disk.

6. The apparatus of claim 5 wherein the optical disk is a CD-ROM.

7. The apparatus of claim 1 further comprising:
a CD-ROM player associated with the storage section means.

8. The apparatus of claim 1 further comprising:
a network with a server in communication with the control unit.

9. The apparatus of claim 1 further comprising:
a keyboard connected to the housing.

10. The apparatus of claim 1 further comprising:
a loudspeaker connected to the amplifier.

11. The apparatus of claim 1 wherein the display is a screen.

12. The apparatus of claim 1 wherein the display is a VGA monitor.

13. The apparatus of claim 1 further comprising:
a coin processing unit connected to the operating element.

14. The apparatus of claim 1 further comprising:
a power supply unit connected to the control unit.

15. The apparatus of claim 1 wherein the compressed data information is MPEG encoded, and further wherein the control unit restores the compressed data information by MPEG decoding.

16. A jukebox comprising:
an audio system;
an operating element connected to the audio system;
storage section means for storing program information and data information wherein the data information is compressed;
a control unit means connected to the audio system, the operating element, and the storage section means wherein the control unit restores the compressed data information and plays the data information on the audio system in response to manual actuation of the operating element; and
a money processing unit connected to the control unit means wherein the money processing unit receives a payment to activate the control unit means.

17. The jukebox of claim 16 further comprising:
a display connected to the control unit means wherein the control unit restores the compressed data information and activates the data information to visually depict a sequence on the display in response to manual actuation of the operating element.

18. The jukebox of claim 16 further comprising:
a housing wherein the storage section means and the control unit means are within to the housing.

19. The apparatus of claim 16 wherein the compressed data information is MPEG encoded, and further wherein the control unit means restores the compressed data information by MPEG decoding.

20. A gaming apparatus comprising:
a display;
an operating element connected to the audio system and connected to the display;
storage section means for storing program information and data information wherein the data information is compressed;
a control unit connected to the display, the operating element, and the storage section means wherein the control unit restores the compressed data information and visually depicts a game sequence on the display in response to actuation of the operating element; and
a money processing unit connected to the control unit wherein the money processing unit receives a payment to activate the control unit.
